(19) United States
(12) Patent Application Publication
(10) Pub. No.: US 2002/0125713 A1
(43) Pub. Date: Sep. 12, 2002

(54) Method of collating, tabulating and retaining personal medical data

(76) Inventor: Michael F. Raab, Bethlehem, PA (US)

Correspondence Address: SANFORD J. PILTCH, The Somach Building, Suite 201, 1132 Hamilton Street, Allentown, PA, 18101, US

(21) Appl. No.: 10/122,515

(22) Filed: Apr. 11, 2002

Related U.S. Application Data
(63) Continuation-in-part of application No. 09/802,769, filed on Mar. 12, 2001, now abandoned.

(51) Int. Cl. B42D 15/00

(52) U.S. Cl. 283/73

(57) ABSTRACT

An organizational tool for use by individuals in providing a portable container holding consolidated personal medical and health information from both traditional and non-traditional sources on a plurality of sheets having specialized formats for the recording of such information including healthcare directives, personal information, medications, treatments and test results.

### FIELD OF THE INVENTION

The present invention is a method for collating and tabulating personal medical information pertinent to the treatment of an individual which is utilized to assist the individual in organizing information regarding ongoing medical treatment, i.e., creating a personal medical history record for retention by the individual.

### BACKGROUND OF THE INVENTION

People have expressed interest in taking a more active role in managing their own healthcare. There are personal organizers; computer databases; hospital and medical caregiver generated medical records; but this information exists in different locations and in varying formats such that the information is fragmented. Patients may go to a medical specialist and records of tests already performed by other caregivers are not available, or are not accessible immediately, or are not known to have been performed. Patients may visit one physician for treatment of an acute illness and forget to have their cancer screening. Children of older persons visit from out of town and have difficulty determining the health and present care of their parent. Patients think of questions between visits to the doctor and forget them by the time of their visit. People experience side effects with certain medications and then are given the same medication by a different caregiver who was unaware of the earlier treatment and reaction for the reason that the patient could not recall or the caregiver did not have access to the treatment records. Patients traveling, or in an emergency treatment facility, may not be able to recall much of their medical history. Sometimes, patients receiving alternative treatments fail to mention these treatments to their primary physician. Also people fail, or neglect to formulate advance directives for prospective treatment with either their primary physician, or with other healthcare providers. The present invention is specifically designed to create a personal record for the patient which will serve as a portable medical care organizer and reminder system.

There are a number of medical record keeping systems which provide a method of recording medical information relative to an individual patient. Unfortunately, these systems are computer based with data entry by persons other than the patient and, when portable, require a specialized device to “read” the information which was recorded in electronic form. One patent which describes such a system is U.S. Pat. No. 5,682,526 [Smokoff, et al.] for “Method and System for Flexibly Organizing, Recording, and Displaying Medical patient Care Information Using Fields in a Flowsheet”. This patent describes a computer based system for use by a patient information management facility for customizing patient information to be recorded in a computer format. The specific utilization is for developing a hierarchy of data linking a number of parameters for date entry having the capability to define specific values and viewable reports for selected patients.

Another system is described in U.S. Pat. No. 5,827,180 [Goodman] entitled “Method and Apparatus for a Personal Health Network”. This is an information system design for use by a healthcare network such that collected information from a particular healthcare provider is processed by algorithms developed for individual patient use in a computing device maintained by the healthcare network for display on a device in the possession of the patient. The patient is able to use the device following computer prompts requesting physiological information and data to be entered into the device with resulting instructions displayed in a message produced by the device advising the patient of a recommended course of treatment. A system for recording and retrieving personal medical information is described in U.S. Pat. No. 6,082,776 [Feinberg] entitled “Storing Personal Medical Information”. The system described uses structured multiple, updateable, static dictionaries for recording medical histories and generating a probable treatment course. The information history is transferable to a portable medical information card which requires a special card reader to display the imprinted information.

Some other devices which have been created to deal with only one part of a patient's treatment may be summarized as follows. U.S. Pat. No. 5,127,756 [Lumm] for “Multi-Compartment Device for Medical Applications” describes a number of tabbed vinyl sheets identifying individual patients in residence at a healthcare facility where the individual sheets contain information pertaining to the medical treatment requirements for that patient. Another apparatus described in U.S. Pat. No. 5,636,873 [Sonsteby] entitled “Medical Documentation and Assessment Apparatus” includes pre-printed adhesive-backed notepads with medical assessment steps which can be temporarily placed on a healthcare facility patient medical chart or permanently placed in a patient medical history maintained by the healthcare facility to denote treatment. A pain indication report form is described in U.S. Pat. No. 5,984,368 [Cain] is entitled “Patient Condition and Pain Location and Intensity Communication Apparatus and Method”. This apparatus allows the patient to record and deliver to the healthcare provider a record of pain location and intensity for inclusion in the patient's medical history maintained by the healthcare provider. None of the foregoing apparatus or methods provide for a patient recorded and maintained record as conceived and utilized by the present invention.

### SUMMARY OF THE INVENTION

The primary purpose of the present invention is to assist individual patients, and patients' families, organize their respective medical care. The personal medical record utilizes section dividers in a loose-leaf binder format with pre-printed section corresponding pages to avail the patient, caregiver, or healthcare provider in creating and maintaining a clear and complete record of their medical treatment, testing and screening data, and personal information and directives. The present invention provides a portable medium which is maintainable without the need for specialized or computer entry devices and is capable of including information derived from healthcare facilities, out-patient treatments and testing, and medical practitioner office visits. The loose-leaf format also allows for information and data enhancements through the addition of calendars, card holders for medical insurance, doctor, and healthcare facility information, medical insurance health bulletins, records of healthcare facility testing, and prescription disclosures, among other like information sheets.

The invention may also be utilized by the individual patients to act as a calendar reminder system for preventive medical visits and other healthcare treatments or testing. The invention further provides a coordinated location for contact information relative to the individual including family, caregiver or neighbor(s), clergy, primary physician, and other healthcare providers, including specialist practitioners visited on a recurring basis. The contact information may also include medical or health insurance policy and contact telephone numbers, pre-certification requirements, and a listing of additional healthcare providers and insurance information.

The invention can be summarized as a method for the collating, tabulating and retaining of personal medical and health information by an individual comprising the steps of providing a portable sheet container for securely containing and storing a plurality of pages for recording the personal medical and health information of the individual, dividing the portable sheet container into sections for organizing the plurality of pages for recording the personal medical and health information of the individual in like information sets, providing a plurality of pages including a contents listing for each section of like information sets in the portable sheet container for recording specialized information pertaining to the personal medical and health information of the individual, cross-indexing the section contents listing pages to other pages within the same section containing additional specialized information pertaining to the personal medical and health information of the individual, and recording the specialized information pertaining to the personal medical and health information of the individual onto the plurality of pages in the appropriate section for organizing like information sets. Each of the sections for organizing the personal medical and health information includes sections titled personal, caregivers, medication, treatment, tests, test results, and tracking test results.

The method also includes the step of including specialized information pertaining to the personal medical and health information of the individual contained on test results pages which are interspersed into the appropriate section. The method also includes placing additional contents listing pages in the appropriate section. Additionally, the method also includes placing specialized information pertaining to the personal medical and health information of the individual contained on informational pages from healthcare providers and health insurance entities in the appropriate section. And finally, the method includes the interspersing of additional sheets containing personal medical and health information of the individual in the appropriate section and cross-indexing such additional sheets of contents listing pages for each section.

### BRIEF DESCRIPTION OF THE DRAWINGS

For the purpose of illustrating the invention, there is shown in the drawings forms of the invention which are presently preferred; it being understood, however, that the invention is not limited to the precise arrangements and instrumentalities shown.

FIG. 1 is a depiction of the Personal Section cover page delineating the informational content for such Section and providing summary information and page reference to additional information detail contained on following pages.

FIG. 2 is a depiction of the Caregivers Section cover page delineating the informational content for such Section and providing summary information and page reference to additional information detail contained on following pages.

FIG. 3 is a depiction of the Caregivers Detail pages delineating the informational content for such Detail pages contained on this and following pages.

FIG. 4 is a depiction of the Caregivers Visit pages delineating the informational content for such Visit pages contained on this and following pages.

FIG. 5 is a depiction of the Medication/Treatment Section cover page delineating the informational content for such Section and providing summary information and page reference to additional information detail contained on following pages.

FIG. 6 is a depiction of the Medication/Treatment Detail pages delineating the informational content for such Detail pages contained on this and following pages.

FIG. 7 is a depiction of the Tests Section cover page delineating the informational content for such Section and providing summary information and page reference to additional information detail contained on following pages.

FIG. 8 is a depiction of the Test Results Detail pages delineating the informational content for such Detail pages contained on this and following pages.

FIG. 9 is a depiction of the Tracking Test Results Detail pages delineating the informational content for such Detail pages contained on this and following pages.

### DETAILED DESCRIPTION OF THE INVENTION

The following detailed description is of the best presently contemplated mode of carrying out the invention. The description is not intended in a limiting sense, and is made solely for the purpose of illustrating the general principles of the invention. The various features and advantages of the present invention may be more readily understood with reference to the following detailed description taken in conjunction with the accompanying drawings.

The present invention provides a system, in paper form, and a method for assisting people organize their healthcare information. By utilizing a loose-leaf binder which is divided into a number of sections, each representing a major aspect of a patient's healthcare, i.e. personal, caregiver, treatment, test and other information, It is also possible to use a hardcover binder having a locking mechanism for privacy.

The various Sections can be arranged in any order. Each Section begins with a Table of Contents or reference listing of the sub-sections and pages following within that Section. The first page listing provides a detailed list of the information in the Section and a reference to that information by page or reference number. The Section Table of Contents has the capability of being customized for each patient (or patients) with similar health concerns by pre-printing recommended treatments and tests. The Section Table of Contents is also designed to provide locations for recording information relating to dates services were, or will be performed. This allows a patient, their family, or caregiver to review which services have been performed and which services need to be performed. By diligently recording the information, referring to the recorded information, and utilizing the personal medical record for scheduling future procedures the present invention should significantly decrease redundancy of healthcare services and provided a unity of information per patient, especially when there is more than one caregiver or healthcare provider.

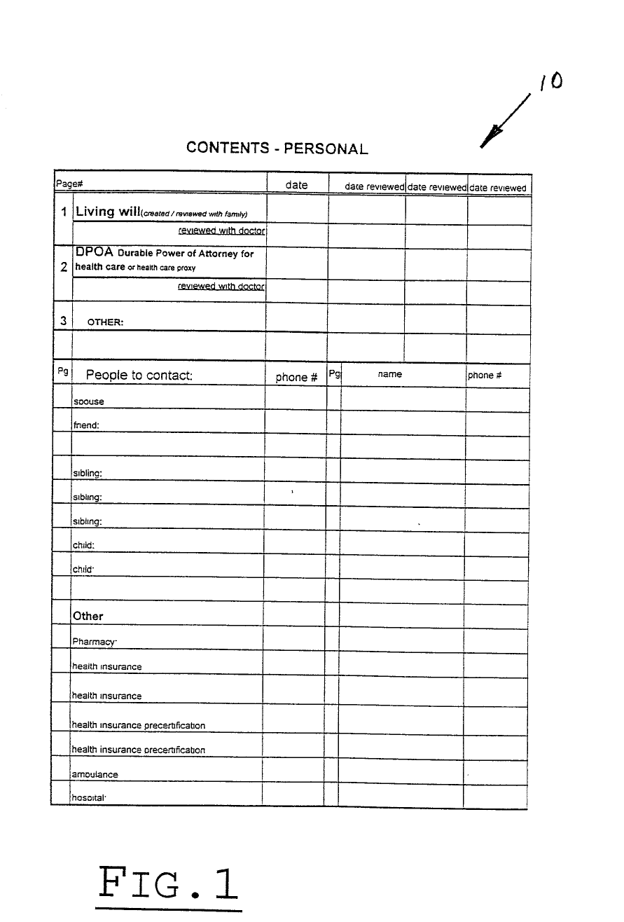

Referring now to the drawings in detail, where like numerals refer to like parts or elements, there is shown in FIG. 1 the initial page of the Personal Section of the present invention. This CONTENTS-PERSONAL page 10 provides a number of locations for the entry or recording of personal information pertaining to contact persons and personal directives authored by the patient. Pages within the Section are reserved for a Living Will (Pg. 1) a Durable Power of Attorney (Pg. 2) and any other important legal document such as a Last Will and Testament. Copies of these documents can be included in the personal medical record of the present invention at the reference page number and information regarding with whom and when these documents were discussed and reviewed can be indicated, as well as the last date on which these directives were updated and the location(s) where copies of these documents may be found. Contact information for a spouse, immediate relatives (children and siblings), and specific healthcare providers can be located on this page, collating all of this type of relevant information in a single location. Some of the personal contact information may include not only the names of the patient's regular pharmacist, but also telephone numbers for other collectors of healthcare records such as medical practitioner's offices, hospitals, ambulance services and medical insurance companies. Some of the contact information can be pre-printed or it can be entered as the information becomes available for later reference. The loose-leaf format permits other sheets containing specific contact information, dates and types of medical insurance coverage, copies of transport agreements from ambulance or transport services, hospital or other healthcare facility in-patient or out-patient treatment dates, etc. Additional CONTENTS-PERSONAL page(s) containing reference page identification information may also be inserted.

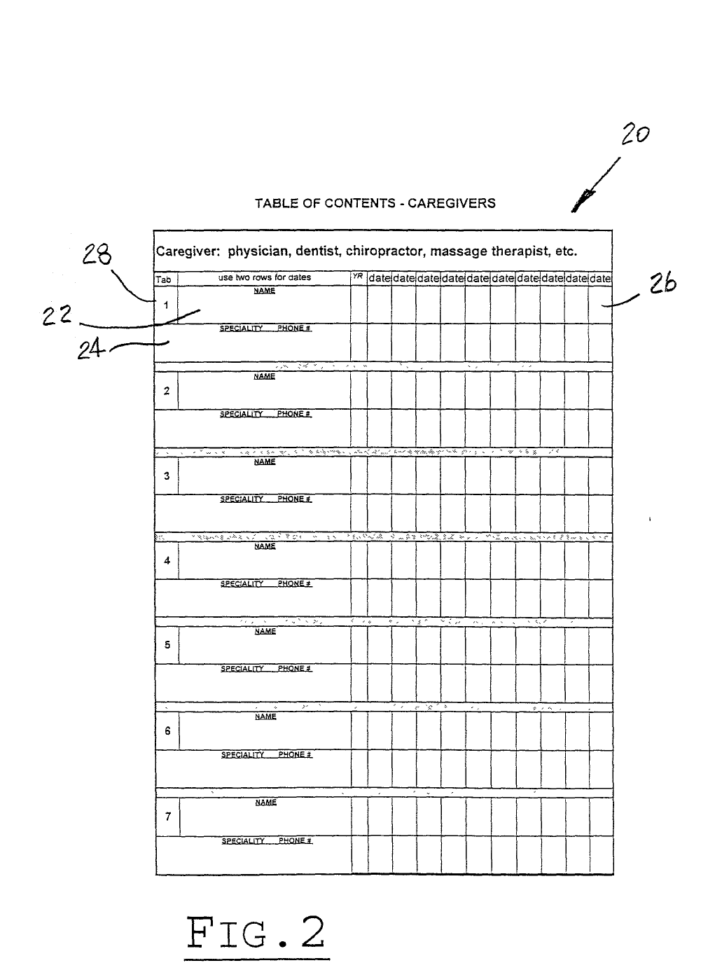

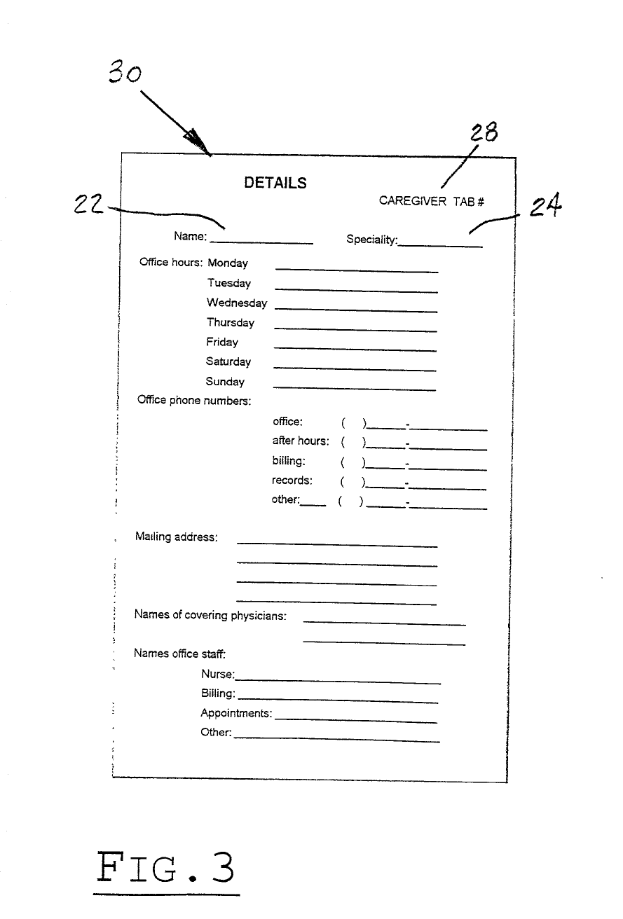

The next Section described will be the Caregiver Section which also begins with a CONTENTS-CAREGIVER page 20 as shown in FIG. 2. The listing on this page provides a summary of identification of the caregivers providing healthcare to the patient. The listing makes reference to following pages providing more detailed information regarding the specific healthcare provider. The summary page allows a patient, their family member(s) or caregiver to view the names 22 and other identifying information such as area of specialty 24, telephone number(s), year in which services began, and a series of contacts or visits with the healthcare provider 26, as well as the reference identification, i.e. tab number reference 28, for the CAREGIVER DETAIL page 30 as shown in FIG. 3. The CAREGIVER DETAIL page 30 is intended to be reproduced for each additional healthcare provider identified in the CONTENTS-CAREGIVER page 20 and placed within the same Section behind the identified tab number in the order set out on the contents page. The CAREGIVER DETAIL page 30 also contains information specific to the named healthcare provider including office hours, office address, staff names and the names of covering personnel. Additional information pertaining to any of the healthcare providers can be placed in the appropriate tab numbered section.

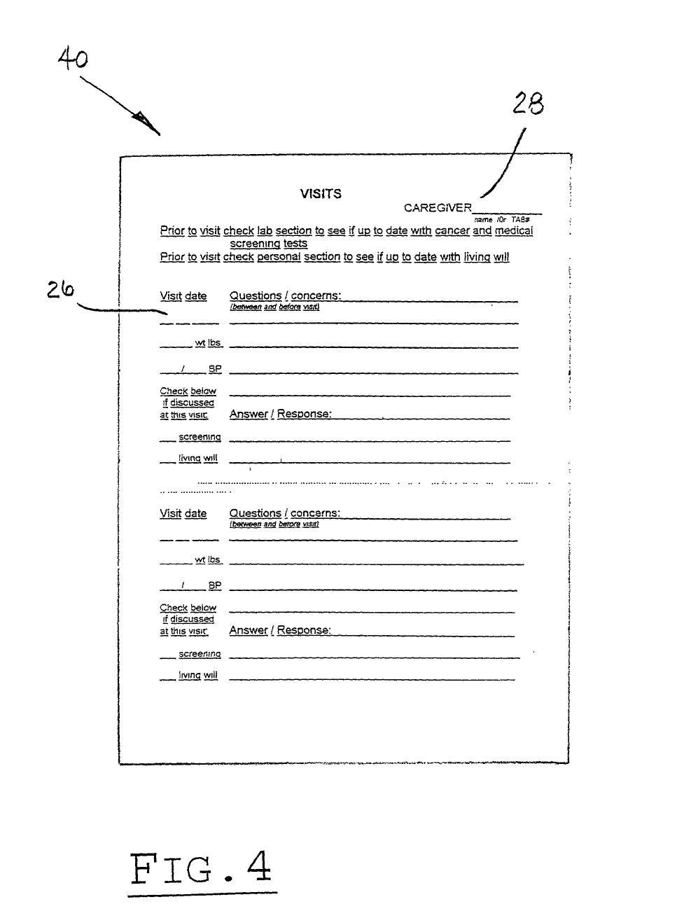

FIG. 4 shows a detailed record CAREGIVER VISIT page 40 which is to be referenced by the caregiver tab reference number 28. This page provide spaces for recording the individual visit date 26 with the caregiver or healthcare provider, and also spaces relating to the context of the visit, i.e. weight, blood pressure measurement, personal directives, and testing requested or discussed, as well as pre-visit recorded questions and the caregiver's response. This page is placed behind the caregiver reference tab for the particular healthcare provider with whom the visit or contact was made. Any number of such CAREGIVER VISIT pages 40 can be created and placed in the personal medical record of the present invention. All, or only the most recent, of the pages may be retained depending upon the need for recalling the information at a later time by the patient.

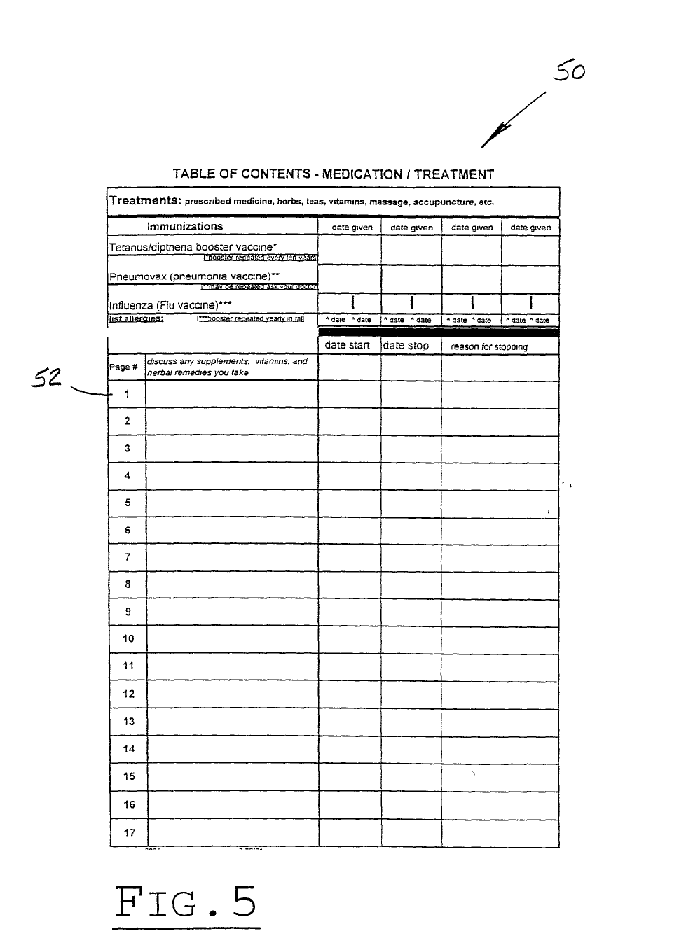

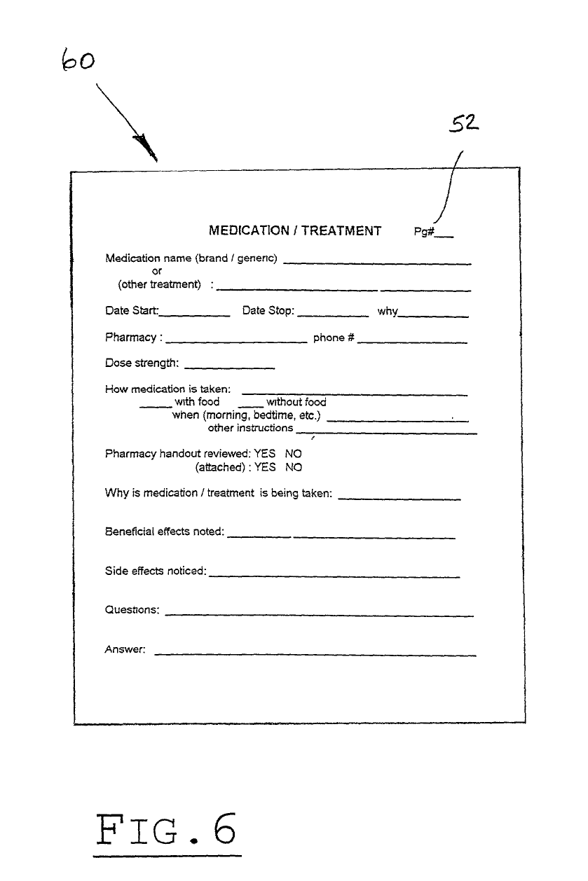

The next Section to be discussed deals with medications and treatments received by the patient and begins with the CONTENTS-MEDICATION/TREATMENT page 50 shown in FIG. 5. This page contains information regarding immunization history, i.e. childhood diseases, later adolescent and adult diseases, allergies and medications (prescription pharmaceuticals, herbal medications or over-the-counter medicines) taken by the patient over the time during which the personal medical record is being used. The CONTENTS-MEDICATION/TREATMENT page 50 contains a number of medication/treatment page reference numbers 52 indicating specific medications or treatments which have been undertaken by the patient. Each of the MEDICATION/TREATMENT DETAIL pages 60, as shown in FIG. 6, are intended to be arranged in numerical order following the indexing appearing on CONTENTS-MEDICATION/TREATMENT page 50. The MEDICATION/ITREATMENT DETAIL pages 60 contain the page identification number 52 and also the identification of the specific medicine or medication (or treatment) which is being undertaken by the patient including dates started and stopped, dosage strength, how taken, what other medicines and medications are being taken, and benefits and side effects to the medications and treatments, if any. There is also a location provided for questions to be asked to the caregiver or healthcare provider, and the particular response. Any number of MEDICATION/TREATMENT DETAIL pages 60 can be placed in this Section of the personal medical record and arranged according to the indexing page reference identification number 52. Additional contents pages listing medications or treatments can be added if the number of page references on the initial page is exceeded.

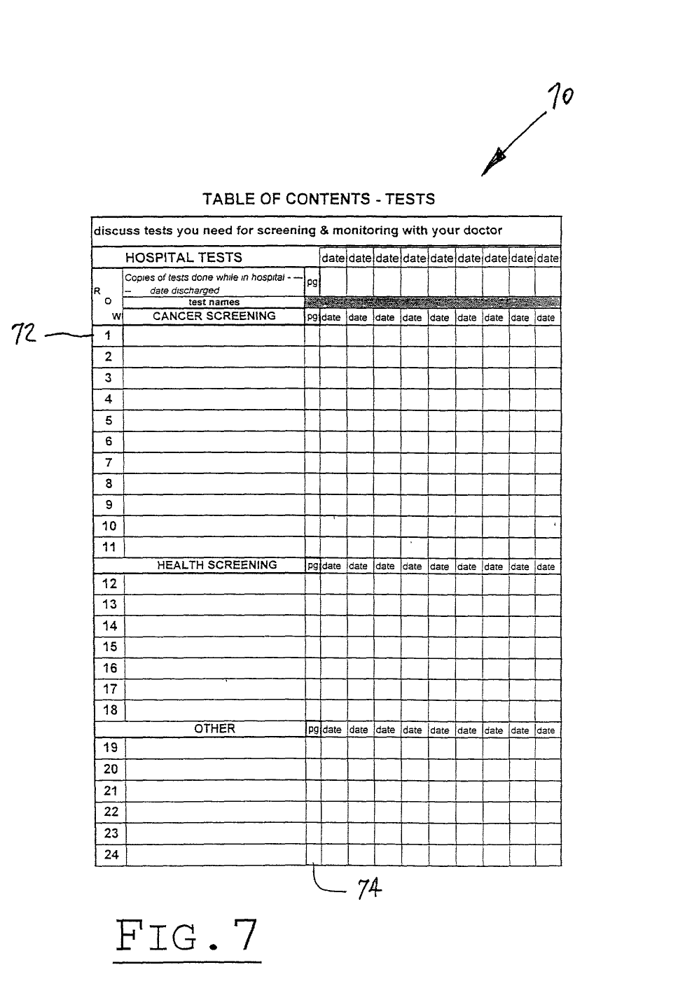

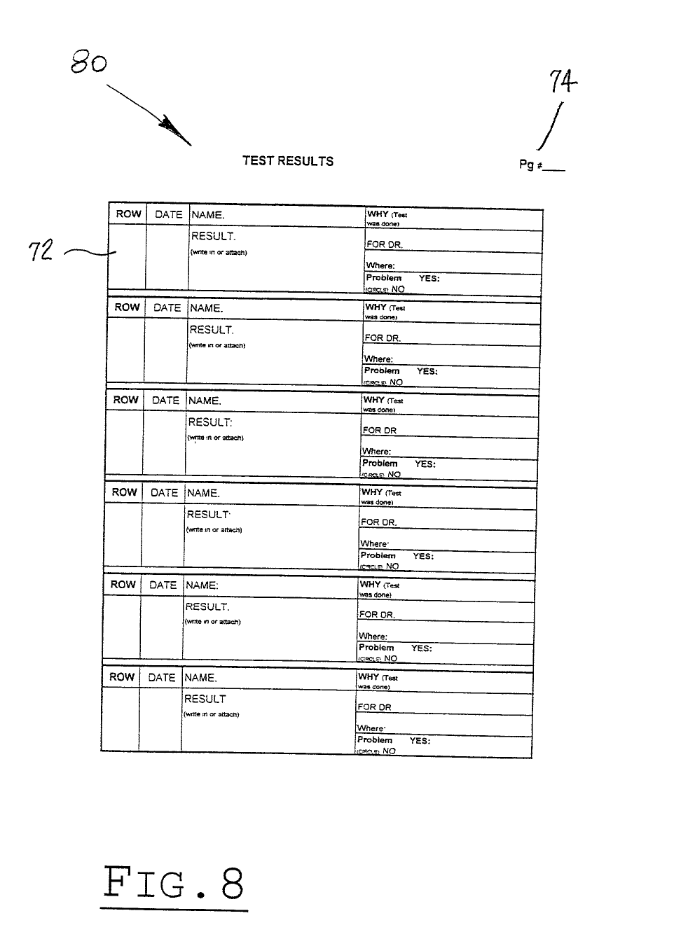

The final Section to be discussed is the Tests Section for which a CONTENTS-TESTS page 70 is shown in FIG. 7. This page is for recording and listing the various tests to which the patient has been subjected, or test(s) recommended to be undertaken by the patient. Each test is listed in the appropriate subsection, i.e. cancer screening, health screening or other, with a reference row number 72 and a reference page number 74 which enable appropriate indexing and appear on the following pages in this Section. The TEST RESULTS page 80, shown in FIG. 8, provides recording locations for up to six (6) separate tests on a single page so that the reference row number 72 and the reference page number 74 will not usually coincide. The TEST RESULTS page 70 provides specific locations for the date of the test 76, who ordered the test (caregiver or healthcare practitioner name), where the test was, or is to be given, the reason for the test, and the result(s) of each test. Particular test results may be attached in the form of laboratory reports, x-ray or scan images, EKG or EEG tracings, and the like which are provided on separate pages. These pages can be inserted immediately following the TEST RESULTS page 80 on which an indexing reference to the following page with the test results can be made in the appropriate location. Due to the uniformity of the TEST RESULTS page 80, and the fact that tests may be grouped by the facility performing the tests, or by relationship to a specific illness, related test results may be recorded on the same page so that tests performed during a hospitalization, including both in-patient and out-patient testing, will be able to be recorded on the same page.

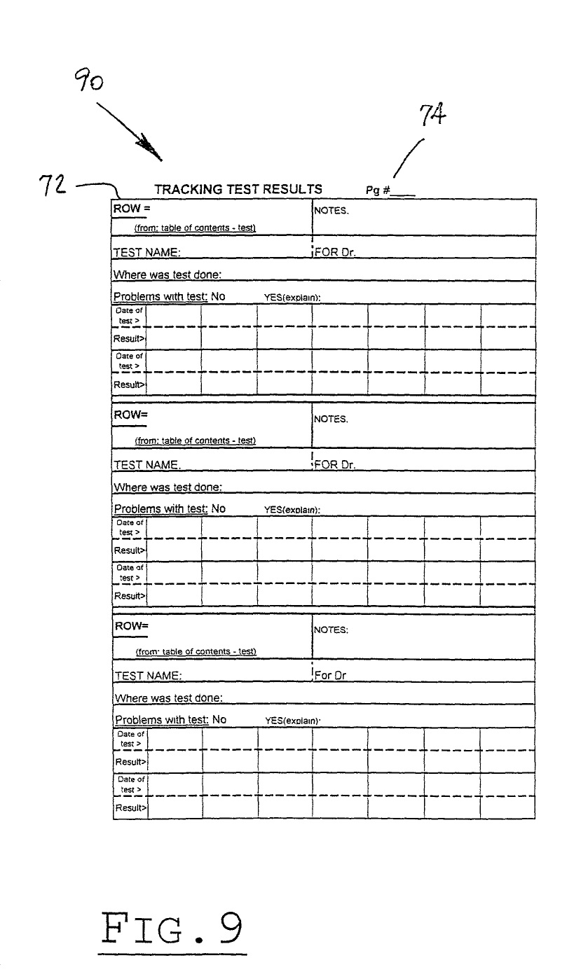

There is also a TRACKING TEST RESULTS page 90, as shown in FIG. 9, which enables the patient to keep track of the results of a series of like tests performed over a period of time in order to detect a change in health condition(s). The TRACKING TEST RESULTS page 90 contains specific locations for test identifying reference row numbers 72 and page identifying reference numbers 74 which will permit the tracking of the series of like tests from the patient referencing the CONTENTS-TESTS page 70. The TRACKING TEST RESULTS page 90 includes locations for recording the name or type of test, the location the test was, or will be performed, the name of the caregiver or healthcare practitioner requesting the test (and to whom the test report will be issued), and the dates of each of the series of like tests. Again, as above, because of the uniformity of the TRACKING TEST RESULTS page 90, and the fact that tests may be grouped by the facility performing the tests, or by relationship to a specific illness, results of related test series may be recorded on the same page so that test series performed over a continuing period of time, including both in-patient and out-patient testing, will be able to be recorded on the same page and as part of the same test series.

Tests which have been suggested by certain screening standards, e.g. by the Taskforce on Preventive Medicine, may be pre-printed in the screening subsection of the CONTENTS-TESTS page 70. Additional pages for any of the pages described above can be added in the appropriate order to accommodate additional test listing, results and tracking.

The present invention may be embodied in other specific forms without departing from the spirit or essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. A method for the collating, tabulating and retaining of personal medical and health information by an individual comprising the steps of:
a) providing a portable sheet container for securely containing and storing a plurality of pages for recording the personal medical and health information of the individual;
b) dividing the portable sheet container into sections for organizing the plurality of pages for recording the personal medical and health information of the individual in like information sets;
c) providing a plurality of pages including a contents listing for each section of like information sets in the portable sheet container for recording specialized information pertaining to the personal medical and health information of the individual;
d) cross-indexing the section contents listing pages to other pages within the same section containing additional specialized information pertaining to the personal medical and health information of the individual; and
e) recording the specialized information pertaining to the personal medical and health information of the individual onto the plurality of pages in the appropriate section for organizing like information sets.

2. The method of claim 1 wherein the sections for organizing the personal medical and health information includes sections titled personal, caregivers, medication, treatment, tests, test results, and tracking test results.

3. The method of claim 1 further comprising the step of including specialized information pertaining to the personal medical and health information of the individual contained on test results pages in the appropriate section.

4. The method of claim 1 further comprising the step of including additional contents listing pages in the appropriate section.

5. The method of claim 1 further comprising the step of including specialized information pertaining to the personal medical and health information of the individual contained on informational pages from healthcare providers and health insurance entities in the appropriate section.

6. The method of claim 1 further comprising the steps of interspersing additional sheets containing personal medical and health information of the individual in the appropriate section and cross-indexing such additional sheets of contents listing pages for each section.
